(19) United States
(12) Patent Application Publication
(10) Pub. No.: US 2014/0241107 A1
(43) Pub. Date: Aug. 28, 2014

(54) Natural peanut butter stirrer

(71) Applicant: William Paul De Feo, New Fairfield, CT (US)

(72) Inventor: William Paul De Feo, New Fairfield, CT (US)

(21) Appl. No.: 13/815,329

(22) Filed: Feb. 22, 2013

(51) Int. Cl. B01F 13/00

(52) U.S. Cl. CPC B01F 13/002
USPC 366/129

(57) ABSTRACT

The invention described in this application is a hand-held utensil for individual consumer use that will stir, mix and blend separated natural peanut butter (solidified peanut butter and peanut oil) into a consistently smooth, spreadable foodstuff. Other stirring products, such as spoons, butter knives, and other so called “peanut butter stirrers” or “mixers” are rendered substantially less effective and inefficient because they cannot be moved easily through the sediment layer of natural peanut butter due to their “flat base” or “flat blade” design. The “NPBS” significantly increases ease of stirring movement by utilizing an open “rounded and looped shaft” design as indicated in hereinbelow.

### BACKGROUND OF THE INVENTION

1. Field of the Invention

The NPBS is in the field of consumer kitchen utensils/devices. It is a one piece, hand held, “no moving parts” implement. It is designed to stir and render smooth the consistency of the product commonly known as natural peanut butter. This product comes to the consumer in a form that requires vigorous mixing. The peanuts are finely ground and in consequence the peanut base and the peanut oil separate. The hard peanut base forms at the bottom of the jar and the peanut oil floats to the top. In order to spread the product it must be thoroughly stirred so that the separated elements of base and oil homogenize into a smooth, spreadable consistency. The NPBS is a strong, rigid, yet slender device whose tines move through the hardened peanut base easily and efficiently. The NPBS is unlike the wide blade of a butter knife, or the broad well of a spoon, or the flat base of other peanut butter stirring devices.

2. Description of Prior Art

Another form of peanut butter stirrer exists in the prior art.

U.S. Patent Application No. 20050190647 by Steven Rosati (Lewis M. Brande, rep.) presents a “Peanut butter stirrer.” This implement consists of a single shaft attached to a narrow handle. The terminus of the single shaft has attached to it what the applicant refers to as “. . . a mixing blade” and again as a “. . . flat blade.” This “blade” is what distinguishes the prior art from the present NPBS submission. The so called “mixing blade” of the prior art perpetuates the same error—has the same shortcomings—of the butter knife, or the teaspoon or tablespoon. These are all tools that present a flattened stirring surface and are therefore inefficient for the stirring of the thick, hardened base of natural peanut butter. The use of a flat surface results in excessive resistance to the solidified base of natural peanut butter. If turned side-ways, any flat base or knife blade will move through the hardened peanut base easily, but will not mix the contents. If turned flatwise and moved perpendicular to the flat blade surface, the implement cannot move through the hard base at all, or hardly at all and then only with great effort. Consequently, in light of the “mixing blade” component, the prior art provides little or no improvement over the butter knife or spoon as a stirrer for natural peanut butter.

### SUMMARY OF THE INVENTION

In light of the inherent inefficiencies in the design of the peanut butter stirrer as represented in the prior art, the present invention, the NPBS, presents an improved, innovative and superior design. It provides for greater efficiency by allowing the stirrer to move through the base easily producing a smoother end-use product in less time and with less troublesome, manual labor. The particular elements of the invention and its advantages over the prior art will be provided below in greater detail.

The detail mentioned above will be provided in part by the illustrations that show particularly the distinction in design between the prior art and the NPBS, an implement to efficiently stir, mix and homogenize the consumer product known as natural peanut butter.

### DESCRIPTION OF THE DRAWINGS

FIG. 1 “1” shows a “Perspective View” of the Natural Peanut Butter Stirrer (NPBS);

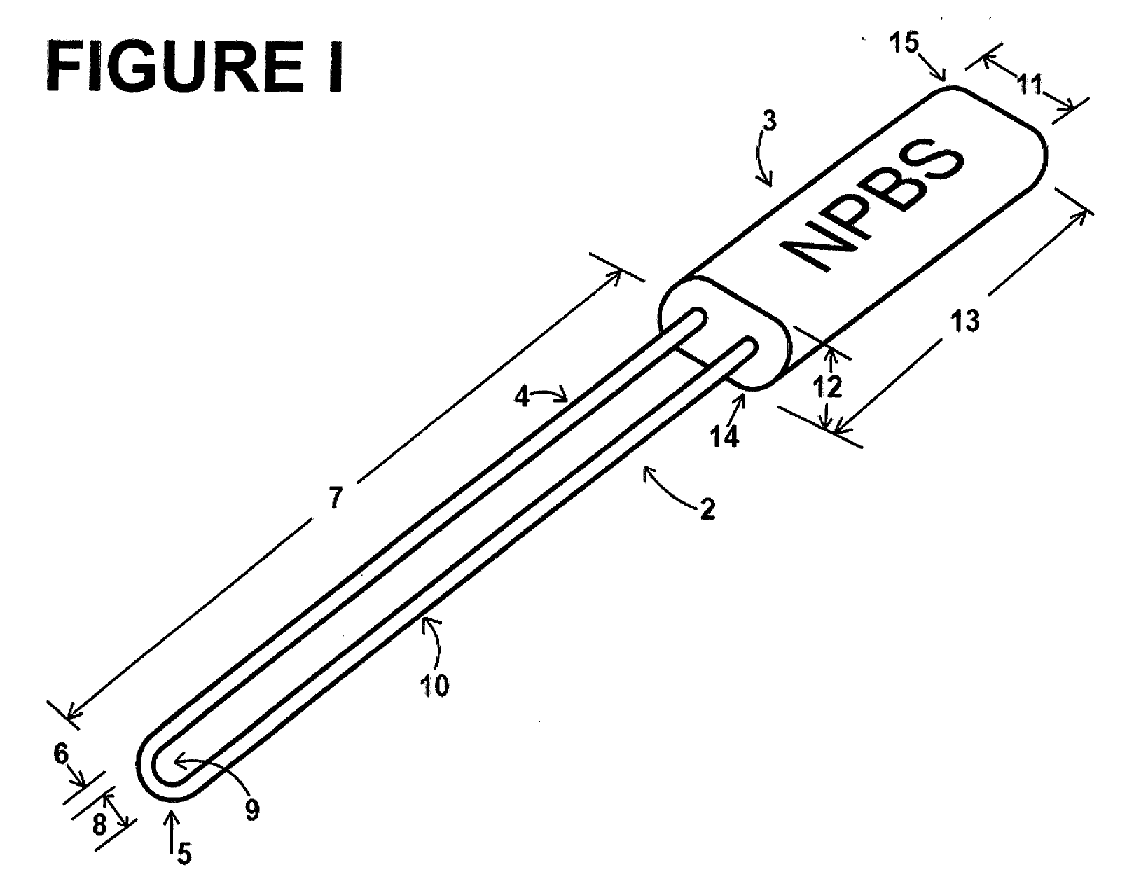

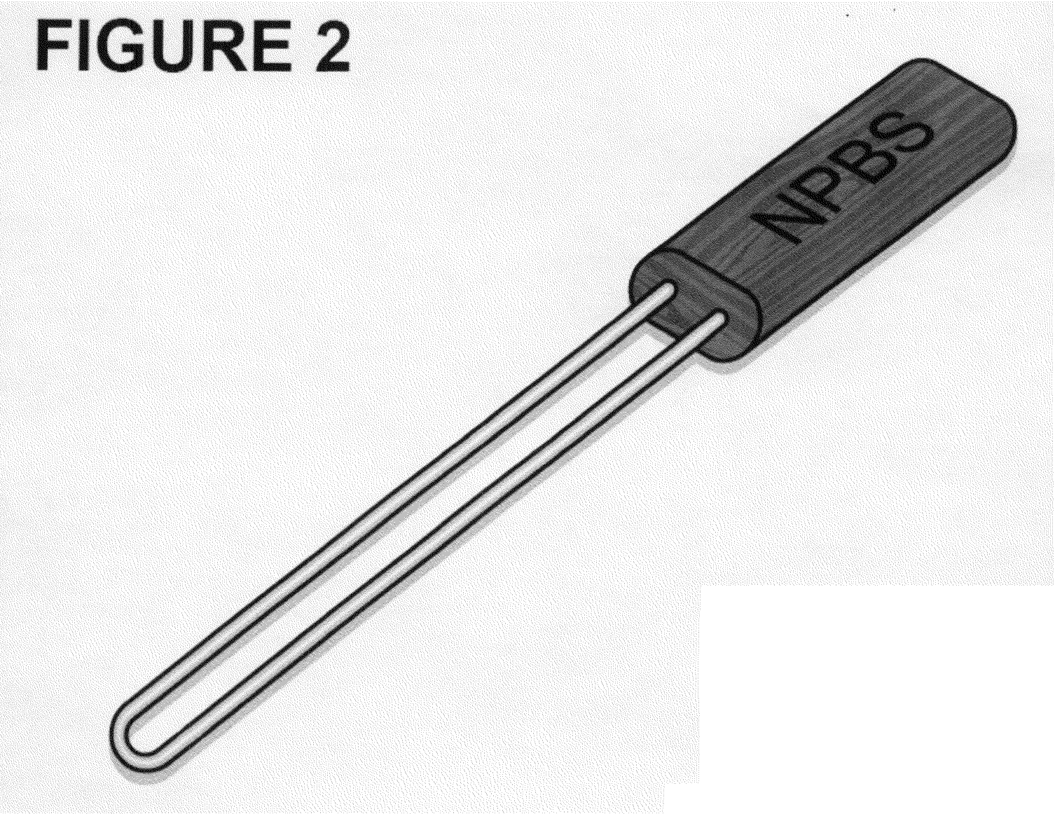

FIG. “2” shows a “Mechanical-Dimensional View” of the NPBS; four (4) sides are presented, namely a front view, a side view, a top view and a bottom view.

### DETAILED DESCRIPTION OF THE PREFERRED EMBODIMENTS

In regard to FIG. “1,” as set forth above” the subject “Natural Peanut Butter Stirrer” (2) is shown having a rounded-edged, wooden handle (3) into which is firmed embedded two ends of a rigid, smooth, stainless steel rod (4), which rod terminates at the end opposite to the handle of the utensil in a three quarters, rounded radial loop (5) at the distal end. The rod has a radial thickness (6) sufficient to retain more than sufficient rigidity to achieve its purpose, and extends to a length (7) that will permit insertion of the rod tines into product containers of various sizes. The distance maintained laterally between the rod tines (8) allows for the hardened, unmixed product to move both through and around the rod tines. The smoothness of the rod and the open-loop end of the utensil (9) provides for reduced product resistance. The entire rod (10) is round and smooth so as to provide for insertion into product containers of any material (glass, plastic, vinyl, etc.) without cutting or scratching the internal surface of the container. The wooden handle of the utensil (3) consists of a width (11), a depth (12) and a length (13) designed to provide for a secure hand-hold. The handle (3) is also equipped with smooth, rounded corners (14) and smooth rounded edges (15) to provide for a comfortable hand-hold. Generally, the preferred material for the rod tines (4) is stainless steel of an industry quality common for use in household food preparation applications. The handle of the appliance (3) is noted in the subject application as consisting of any of a species of hardwoods, as such hardwoods are resistant to potential bacterial growth from the utensil's repeated use and washing. However, the handle (3) may be made of alternative handle-specific materials that share or exceed the bacteria resistant characteristics of hardwoods.

1. The Natural Peanut Butter Stirrer (hereinafter the “NPBS”) is a hand held utensil that consists of:
a. A symmetrical, rectangular, round-edged wooden handle, protruding from which is;
b. one (1) continuous 3/16″ stainless steel rod extending straight out from a hole in the handle, making a close loop at its termination point and returning secured into the handle again.

2. The NPBS of claim “1” above, wherein said handle is made of any variety of dense hardwoods (eg. mahogany, oak, yellow pine, ironwood, etc.) and is designed with a sufficient thickness to allow for the secure grip of the hand necessary to accomplish stirring of the hard sediment peanut butter base with the separated peanut butter oil;

3. The NPBS of claim “1” above, wherein the steel rod is made of that special variety of “food quality” stainless steel as industry standards shall dictate (eg. 440 stainless steel);

4. The NPBS of claim “1” above, wherein the “loop” so referenced is created by the open spaced, yet parallel tines of the stainless steel rod, which smooth loop shape eliminates piercing or cutting through the soft plastic of many commercially available natural peanut butter containers, which piercing and cutting commonly occurs with other sharp edged, sharp cornered stirring devises;

5. The NPBS of claim “1” above, wherein the “loop” so referenced, as the term “loop” indicates, has no “blade” or “flat base” or “spoon” shape or form at its terminus, but rather allows the solidified, unmixed peanut butter base to move both around and through the stirrer and mix the sediment base with considerably less resistance, with more efficiency and reduced manual effort.
